(19) United States
(12) Patent Application Publication
(10) Pub. No.: US 2012/0111820 A1
(43) Pub. Date: May 10, 2012

(54) Storage Rack

(75) Inventor: Gary M. Lim, Palos Verdes Peninsula, CA (US)

(73) Assignee: SEVILLE CLASSICS, INC., Torrance, CA (US)

(21) Appl. No.: 13/347,412

(22) Filed: Jan. 10, 2012

Related U.S. Application Data
(63) Continuation of application No. 11/515,592, filed on Sep. 5, 2006, now Pat. No. 8,096,430.

(30) Foreign Application Priority Data
Nov. 24, 2005 (CN) 200520142171.4

(51) Int. Cl. A47B 43/00; B23P 11/00

(52) U.S. Cl. 211/204; 29/428

(57) ABSTRACT

A rack for holding articles includes a plurality of sets of vertical battens, a plurality of sets of horizontal battens that are clamped together with the plurality of sets of vertical battens, a long connecting screw piece that extends through each set of horizontal and vertical battens, and a supplementary connecting screw that connects the front horizontal batten and the front vertical batten. The screw piece defines a pivot axis for folding the battens.

### RELATED CASES

This is a continuation application of co-pending Ser. No. 11/515,592, filed Sep. 5, 2006, now U.S. Pat. No. 8,096,430, whose disclosures are incorporated by this reference as though fully set forth herein.

### BACKGROUND OF THE INVENTION

1. Field of the Invention

The present invention relates to an article-holding rack for placing common household articles, and in particular, to a rack for holding articles.

2. Description of the Prior Art

Article-holding racks are used by people in their daily lives to hold common household articles such as towels, clothes, shoes, etc. Many of these racks can be folded or dis-assembled to reduce that overall size and profile for storage and transportation. Unfortunately, many of these conventional racks are still difficult to fold, or assemble and disassemble, so that storage and transport can be inconvenient.

### SUMMARY OF THE INVENTION

It is an object of the present invention to provide a rack for holding articles.

It is another object of the present invention to provide a rack that is easy to deploy and to store.

The present invention provides a rack that includes a plurality of sets of vertical battens, a plurality of sets of horizontal battens that are clamped together with the plurality of sets of vertical battens, a long connecting screw piece that extends through each set of horizontal and vertical battens, and a supplementary connecting screw that connects the front horizontal batten and the front vertical batten. The screw piece defines a pivot axis for folding the battens.

### BRIEF DESCRIPTION OF THE DRAWINGS

FIG. 1 is an exploded perspective view of a rack according to one embodiment of the present invention.

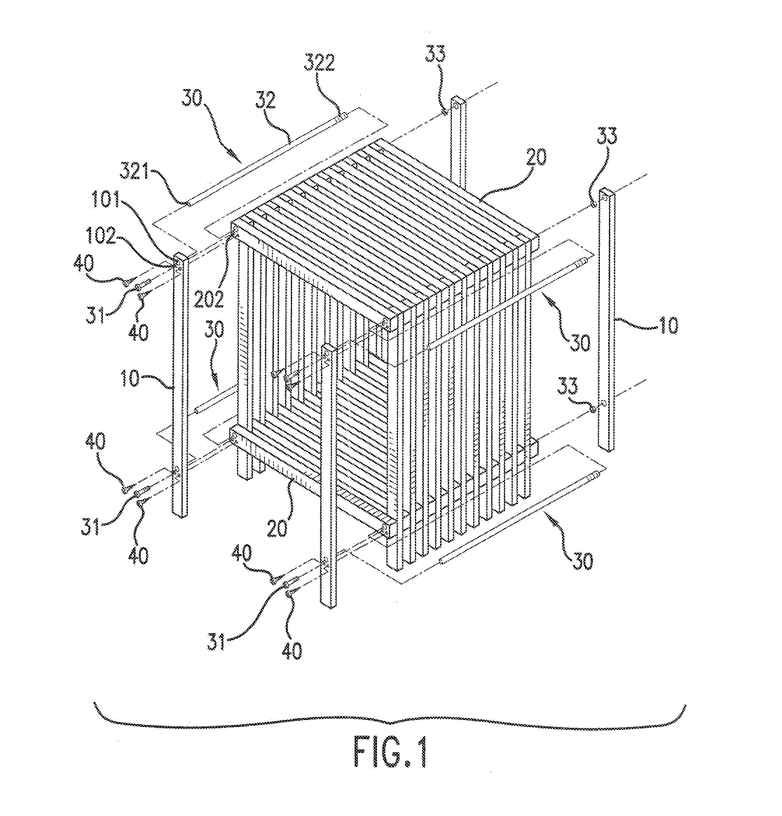

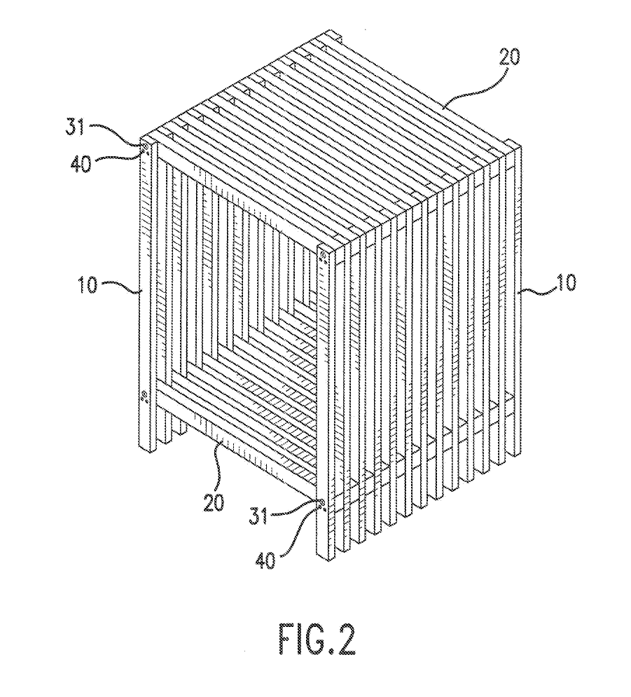

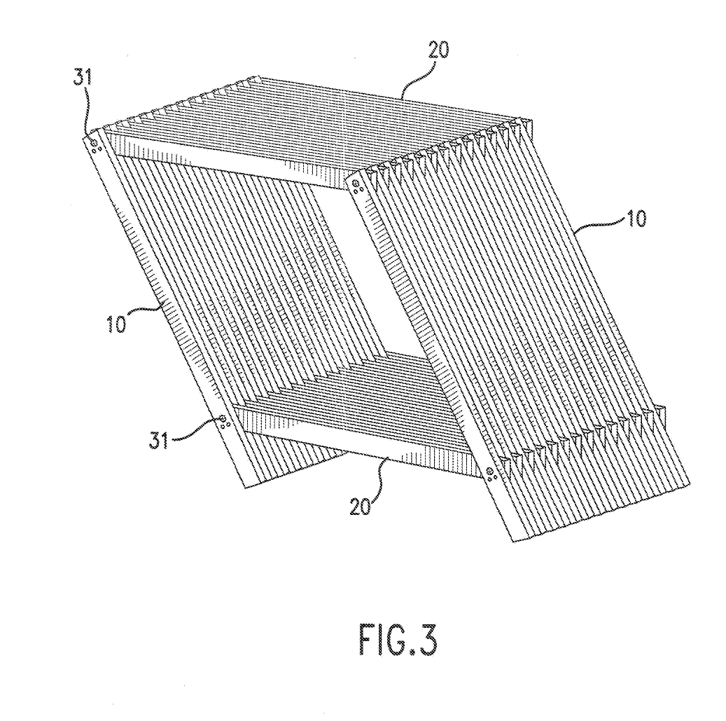

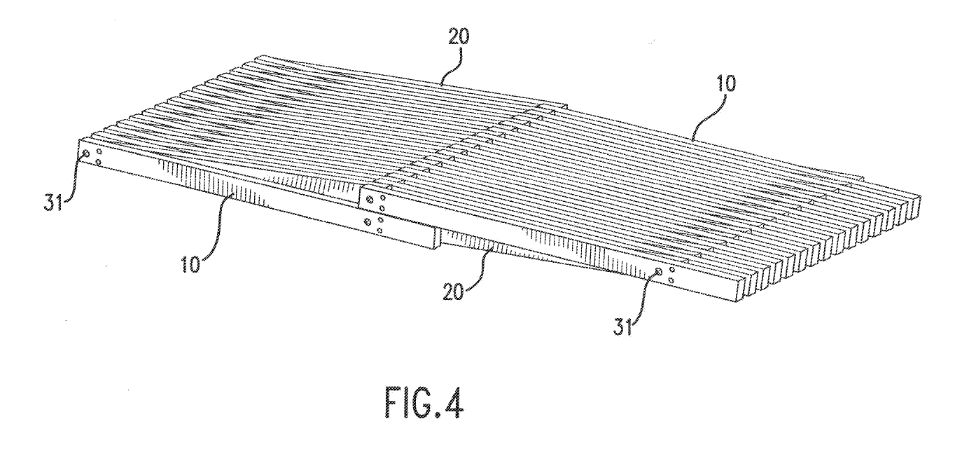

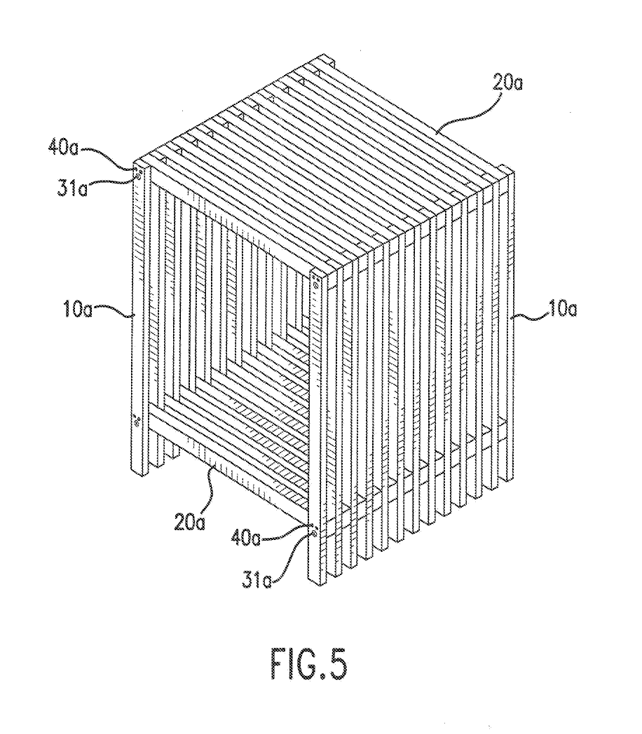

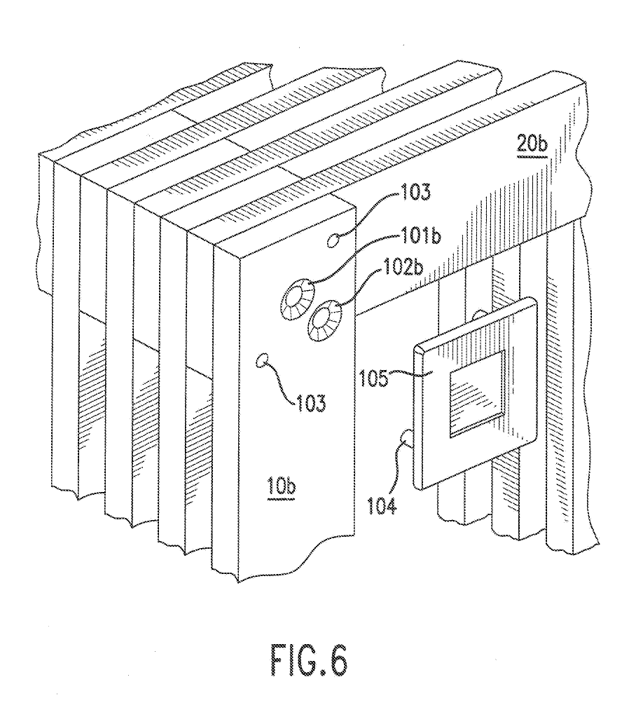

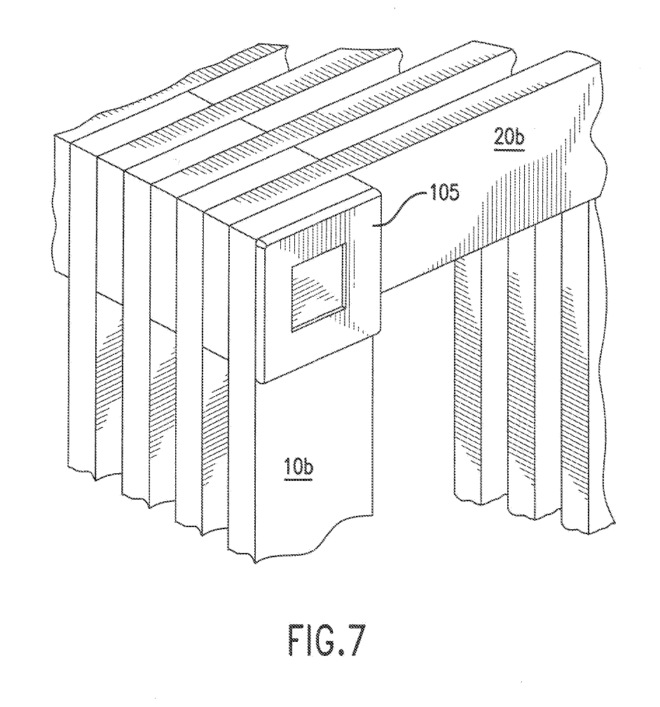

1-10. (canceled)

11. A rack for holding articles, the rack being pivotable between a folded orientation and a deployed orientation, comprising:
a first set of vertical battens, the first set of vertical battens having at least three battens;
a first set of horizontal battens, the first set of horizontal battens having at least three battens;
a long connecting screw piece that extends through each batten in the first sets of horizontal and vertical battens with each of the vertical and horizontal battens being positioned directly adjacent to another of the vertical and horizontal battens, the screw piece defining a pivot axis;
wherein the horizontal and vertical battens are foldable about the pivot axis between the folded orientation and the deployed orientation; and
wherein the horizontal battens are pivotally connected to the vertical battens with all the horizontal battens disposed at right angles with all the vertical battens when the rack is in the deployed orientation, and wherein all the horizontal battens are parallel to a support surface on which at least two of the vertical battens are rested upon.

12. The rack of claim 11, further including a second set of vertical battens, the second set of vertical battens having at least three battens, with each batten in the second set of vertical battens being parallel to each batten in the first set of vertical battens when the rack is in the deployed orientation.

13. The rack of claim 12, further including a second set of horizontal battens, the second set of horizontal battens having at least three battens, with each batten in the second set of horizontal battens being parallel to each batten in the first set of horizontal battens when the rack is in the deployed orientation.

14. The rack of claim 11, further including a locking screw spaced apart from the long connecting screw piece, and having an axis separate but parallel from the pivot axis, the locking screw connecting some but not all of the battens of the vertical and horizontal battens along the locking screw axis.

15. The rack of claim 14, further including a front vertical batten, a rear vertical batten, a front horizontal batten and a rear horizontal batten, and wherein the locking screw connects the front horizontal batten and the front vertical batten.

16. The rack of claim 11, wherein the screw piece comprises:
a connecting rod that passes through all of the battens in the first set of vertical battens and the first set of horizontal battens, the connecting rod having a front end and a rear end, and the first set of vertical battens having a front vertical batten and a rear vertical batten;
a screw that passes through the front vertical batten and is connected to the front end of the connecting rod; and
a screw hat that is provided adjacent the rear vertical batten and is coupled to the rear end of the connecting rod.

17. The rack of claim 11, wherein each horizontal batten of the first set of horizontal battens is alternated by each vertical batten of the first set of vertical battens.

18. The rack of claim 11, further including a cover pad that is removably coupled to either a front horizontal batten or a front vertical batten at the location of the screw piece.

19. A rack for holding articles, the rack being pivotable between a folded orientation and a deployed orientation, comprising:
a first set of vertical battens, the first set of vertical battens having at least three battens;
a first set of horizontal battens, the first set of horizontal battens having at least three battens;
a long connecting screw piece that extends through each batten in the first sets of horizontal and vertical battens with each of the vertical and horizontal battens being positioned directly adjacent to another of the vertical and horizontal battens, the screw piece defining a pivot axis;
wherein the horizontal and vertical battens are foldable about the pivot axis between the folded orientation and the deployed orientation; and
wherein the horizontal battens are pivotally connected to the vertical battens with all the horizontal battens disposed at right angles with all the vertical battens when the rack is in the deployed orientation, and wherein none of the horizontal battens contact a support surface on which at least two of the vertical battens are rested upon.

20. The rack of claim 19, wherein each batten in the first set of horizontal battens is disposed at right angles with all the battens in the first set of vertical battens when the rack is in the deployed orientation.

21. The rack of claim 19, further including a second set of vertical battens, the second set of vertical battens having at least three battens, with each batten in the second set of vertical battens being parallel to each batten in the first set of vertical battens when the rack is in the deployed orientation.

22. The rack of claim 21, further including a second set of horizontal battens, the second set of horizontal battens having at least three battens, with each batten in the second set of horizontal battens being parallel to each batten in the first set of horizontal battens when the rack is in the deployed orientation.

23. The rack of claim 19, further including a locking screw spaced apart from the long connecting screw piece, and having an axis separate but parallel from the pivot axis, the locking screw connecting some but not all of the battens of the vertical and horizontal battens along the locking screw axis.

24. The rack of claim 23, further including a front vertical batten, a rear vertical batten, a front horizontal batten and a rear horizontal batten, and wherein the locking screw connects the front horizontal batten and the front vertical batten.

25. The rack of claim 19, wherein the screw piece comprises:
a connecting rod that passes through all of the battens in the first set of vertical battens and the first set of horizontal battens, the connecting rod having a front end and a rear end, and the first set of vertical battens having a front vertical batten and a rear vertical batten;
a screw that passes through the front vertical batten and is connected to the front end of the connecting rod; and
a screw hat that is provided adjacent the rear vertical batten and is coupled to the rear end of the connecting rod.

26. The rack of claim 19, wherein each horizontal batten of the first set of horizontal battens is alternated by each vertical batten of the first set of vertical battens.

27. The rack of claim 19, further including a cover pad that is removably coupled to either a front horizontal batten or a front vertical batten at the location of the screw piece.
